(19) United States
(12) Patent Application Publication
(10) Pub. No.: US 2026/0358491 A1
(43) Pub. Date: Nov. 12, 2026

(54) Method and Device for Determining the Tangential Speed of an Object

(71) Applicant: Bayerische Motoren Werke Aktiengesellschaft, Muenchen (DE)

(72) Inventors: Juan Carlos FUENTES MICHEL, Muenchen (DE); Stefan HOLZKNECHT, Feldkirchen (SE)

(21) Appl. No.: 19/122,306

(22) PCT Filed: Sep. 26, 2023
(86) PCT No.: PCT/EP2023/076495

§ 371 Date: Apr. 18, 2025

(30) Foreign Application Priority Data
Oct. 20, 2022 (DE) 10 2022 127 669.4

(51) Int. Cl. G01S 13/58; G01S 13/06

(52) U.S. Cl. CPC G01S 13/58; G01S 13/06

(57) ABSTRACT

The invention relates to a device for determining speed information relating to the tangential speed of an object in the surroundings of a radar sensor. The radar sensor is designed to transmit a transmission signal and to receive, at a plurality of receiving antennas, a corresponding plurality of reception signals, each of which is dependent on the transmission signal. The transmission signal has a frequency ramp in each of N temporally successive time intervals. The device is configured to determine, on the basis of the plurality of reception signals and on the basis of the transmission signal, angle information relating to a detection angle for the object for each of the N time intervals. The device is furthermore configured to determine the speed information relating to the tangential speed of the object on the basis of the temporal sequence of angle information relating to the detection angle.

### BACKGROUND AND SUMMARY

The invention relates to a method and a corresponding device which are directed to determining the tangential speed of an object based on the sensor data of a radar sensor.

A vehicle guided in an at least semiautomated manner has one or more surroundings sensors, which are configured to detect sensor data with respect to the surroundings of the vehicle. The sensor data can be evaluated to provide a driving function, by which the vehicle is longitudinally and/or laterally guided in an at least semiautomated manner. The vehicle can in particular comprise a radar sensor as a surroundings sensor in order to detect objects in the surroundings of the vehicle. The radial speeds of the individual objects (in the radial direction with respect to the radar sensor) can also be determined here on the basis of the sensor data of the radar sensor, in particular on the basis of the Doppler effect.

The present document relates to the technical object of determining reliable and precise information with respect to the tangential speed of an object (tangential to the acquisition direction of the radar sensor) on the basis of the sensor data of a radar sensor.

The object is achieved by each of the independent claims. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to one aspect, a device is described for determining speed information with respect to the tangential speed of an object in the surroundings of a radar sensor. The radar sensor can be arranged in a vehicle. The tangential speed of the object can be the speed of the movement of the object tangential to a detection direction of the radar sensor (from the detection range of the radar sensor).

The radar sensor can be designed to emit a transmission signal and to receive a corresponding plurality of reception signals, each of which are dependent on the transmission signal (due to a reflection of the transmission signal on the object), at a plurality of reception antennas. The reception antennas can be arranged laterally offset in relation to one another (with respect to the detection range and/or with respect to the detection directions of the radar sensor). The reception antennas can be equidistant to one another here.

The transmission signal can have a frequency ramp in each of N chronologically successive time intervals (N>1, e.g., N=10 or more, or N=20 or more, or N=50 or more). In particular, the transmission signal can be composed of a time sequence of frequency ramps. A frequency ramp can comprise in each case a plurality of different frequencies of the transmission signal here. In other words, the frequency of the transmission signal can change along a frequency ramp, for example starting from a first frequency (possibly fluidly or in steps) to a second (higher) frequency.

The device is configured, on the basis of the plurality of reception signals and on the basis of the transmission signal (for example, by mixing) to determine, for each of the N time intervals, angle information with respect to the detection angle for the object in the respective time interval. In other words, a (time) sequence of angle information with respect to the detection angle for the object in the N successive time intervals can be determined. A digital beamforming method can be used for this purpose.

The device is furthermore configured to determine the speed information with respect to the tangential speed of the object on the basis of the time sequence of angle information with respect to the detection angle. The speed information with respect to the tangential speed, in particular the tangential speed, of the object can in particular be determined on the basis of the change of the angle information, in particular on the basis of the change of the detection angle, along the N time intervals.

The device can be configured, for example, to determine a (time) gradient, with which the angle information, in particular with which the detection angle (on average), changes along the N time intervals (for example, rises or falls). The speed information with respect to the tangential speed of the object can then be determined in a particularly precise manner on the basis of the gradient.

A device is therefore described which is configured to determine a time curve of the detection angle of an object on the basis of the plurality of reception signals. The tangential speed of the object can be determined in an efficient and precise manner based on this time curve.

The device can be configured, on the basis of the plurality of reception signals and on the basis of the transmission signal, by mixing one reception signal in each case with the transmission signal, to determine Q intermediate frequency signals, with Q>1 (e.g., Q=10 or more, or Q=20 or more, or Q=50 or more). The time sequence of angle information with respect to the detection angle, in particular the time sequence of detection angles, can then be determined in a precise manner on the basis of the Q intermediate frequency signals.

The device can be configured, for a specific time interval of the N time intervals, for each of the Q intermediate frequency signals, to determine a value of the phase of the respective intermediate frequency signal in the specific time interval. Therefore, for each of the Q intermediate frequency signals, the value of the phase of the respective intermediate frequency signal in the specific time interval can be determined, so that a sequence of Q values of the phase results (for a corresponding sequence of Q combination index values along the combination dimension, wherein the combination index identifies different combinations of in each case one reception signal and the transmission signal; furthermore the combination index can indicate or specify different lateral distances between different reception antennas).

The angle information with respect to the detection angle for the object in the specific time interval can be determined on the basis of the Q values of the phase of the Q intermediate frequency signals in the specific time interval. The device can be configured in particular to determine a frequency spectrum on the basis of a frequency band transform of the sequence of Q values of the phase of the Q intermediate frequency signals in the specific time interval. The angle information with respect to the detection angle for the object in the specific time interval can then be determined in a precise manner on the basis of the determined frequency spectrum (for example, as the frequency which corresponds to the maximum of the frequency spectrum).

The device can be configured to determine a (possibly three-dimensional) radar tensor having a plurality of cells on the basis of the plurality of reception signals and on the basis of the transmission signal. A corresponding plurality of intermediate band signals can be determined on the basis of the plurality of reception signals and on the basis of the transmission signal (in particular by mixing the individual reception signals with the transmission signal). The measured values for the plurality of cells of the radar tensor can then be determined on the basis of the plurality of intermediate frequency signals, in particular by scanning the plurality of intermediate frequency signals.

The radar tensor can have a long-term dimension. The radar tensor can comprise a (for example, two-dimensional) partial tensor having cells along the long-term dimension for each of the N time intervals.

The partial tensor can have a short-term dimension, wherein the partial tensor comprises a cell along the short-term dimension for each of K sampling times of a frequency ramp (with K>1, e.g., K=20 or more, or K=50 or more, or K=200 or more).

Furthermore, the partial tensor can have a combination dimension, wherein the partial tensor comprises a cell along the combination dimension for each of Q different combinations of a reception signal with the transmission signal.

The device can be configured to carry out a frequency band transform, in particular a Fourier transform, along the short-term dimension for each of the N partial tensors for the corresponding N time intervals, in order to determine distance information with respect to the radial distance of the object (along the detection direction of the radar sensor). A frequency spectrum can be determined along the short-term dimension by the frequency band transform. The radial distance of the object can be indicated by the frequency at which the frequency spectrum has a maximum.

The device can furthermore be configured to carry out a frequency band transform, in particular a Fourier transform, along the combination dimension in particular (possibly only) for cells which correspond to the determined radial distance of the object, in order to determine the angle information with respect to the detection angle for the object for the respective time interval. A frequency spectrum along the combination dimension can be determined by the frequency band transform. The angle information, in particular the detection angle, can be indicated by the frequency at which the frequency spectrum has a maximum.

Therefore (after a frequency band transform along the short-term dimension and before a frequency band transform along the long-term dimension), a frequency band transform can be carried out along the combination dimension in order to determine angle information with respect to the detection angle of the object in the respective time interval for each of the individual time intervals. The tangential speed of the object can thus be determined in a particularly precise manner.

The device can be configured to carry out a frequency band transform, in particular a Fourier transform, along the long-term dimension in particular (possibly only) for cells which correspond to the determined radial distance of the object, without a frequency band transform previously having taken place along the combination dimension. Speed information with respect to the radial speed of the object can then be determined based on the frequency band transform along the long-term dimension.

The device can be configured to determine L corresponding time sequences of angle information with respect to the detection angle of the object on the basis of L (with respect to the detection range or with respect to the detection directions) radar sensors arranged adjacent to one another, with L>1 (e.g., L=2 or more, or L=3 or more). The speed information with respect to the tangential speed of the object can then be determined in a particularly precise manner on the basis of the L time sequences of angle information with respect to the detection angle of the object.

As already described above, the radar sensor can be part of a vehicle. The device can be configured to provide a driving function for automated longitudinal and/or lateral guidance of the vehicle on the basis of the speed information.

According to a further aspect, a (road) motor vehicle (in particular a passenger vehicle or a truck or a bus or a motorcycle) is described, which comprises the device described in this document.

According to a further aspect, a method is described for determining speed information with respect to the tangential speed of an object in the surroundings of a radar sensor (wherein the radar sensor can be arranged in a vehicle). The radar sensor is designed to emit a transmission signal and to receive a corresponding plurality of reception signals at a plurality of reception antennas, which are each dependent on the transmission signal (due to the reflection at an object). The transmission signal has a frequency ramp in each of N chronologically successive time intervals.

Forms of the method comprises determining, on the basis of the plurality of reception signals and on the basis of the transmission signal, for each of the N time intervals, angle information with respect to the detection angle for the object. The method furthermore comprises determining the speed information with respect to the tangential speed of the object on the basis of the time sequence of angle information with respect to the detection angle.

According to a further aspect, a software (SW) program is described. The SW program can be configured to be executed on a processor (for example, on a control unit of a vehicle), and to thus carry out the method described in this document.

According to a further aspect, a storage medium is described. The storage medium can comprise an SW program which is configured to be executed on a processor and to thus carry out the method described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The invention will be described in more detail hereinafter on the basis of exemplary embodiments.

### BRIEF DESCRIPTION OF THE DRAWINGS

FIG. 1a shows an exemplary vehicle having a radar sensor;

FIG. 1b shows an exemplary transmission signal of a radar sensor;

FIG. 2a shows an exemplary measured value tensor of a radar sensor;

FIG. 2b shows an exemplary frequency range tensor for the measured value tensor of a radar sensor;

FIG. 3 shows an exemplary modified frequency range tensor;

FIG. 4 shows a flow chart of an exemplary method for determining speed information with respect to the tangential speed of an object; and

FIG. 5 shows an exemplary distribution of the signal energy for different ramp indexes and for different antenna combination indexes.

### DETAILED DESCRIPTION OF THE DRAWINGS

As described at the outset, the present document relates to the precise determination of the tangential speed of an object, which is arranged in the surroundings of a (motor) vehicle. In this context, Figure la shows an exemplary vehicle 100, which has at least one radar sensor 102 configured to detect sensor data with respect to the surroundings of the vehicle 100, in particular with respect to the surroundings in front of the front of the vehicle 100. The radar sensor 102 can be configured to emit a transmission signal and to receive a reception signal dependent on the transmission signal. The reception signal can be based on a reflection of the transmission signal at an object 105 in the surroundings of the vehicle 100.

The radar sensor 102 can have a specific detection range 120, wherein the detection range 120 has a plurality of different detection directions 121. The plurality of different detection directions 121 can be defined in polar coordinates of a polar coordinate system, wherein the radar sensor 102 is arranged in the point of origin of the polar coordinate system. The different detection directions 121 can have azimuth angles in a specific azimuth angle range. Furthermore, the different detection directions 121 can have elevation angles in a specific elevation angle range. The detection range 120 of the radar sensor 102 can therefore be defined by the combination of azimuth angle range and elevation angle range. Furthermore, a boundary of the detection range can exist with respect to the maximum possible radial distance of detections. Furthermore, the radar sensor 102 can have a specific angle resolution with respect to possible azimuth angles and/or with respect to possible elevation angles.

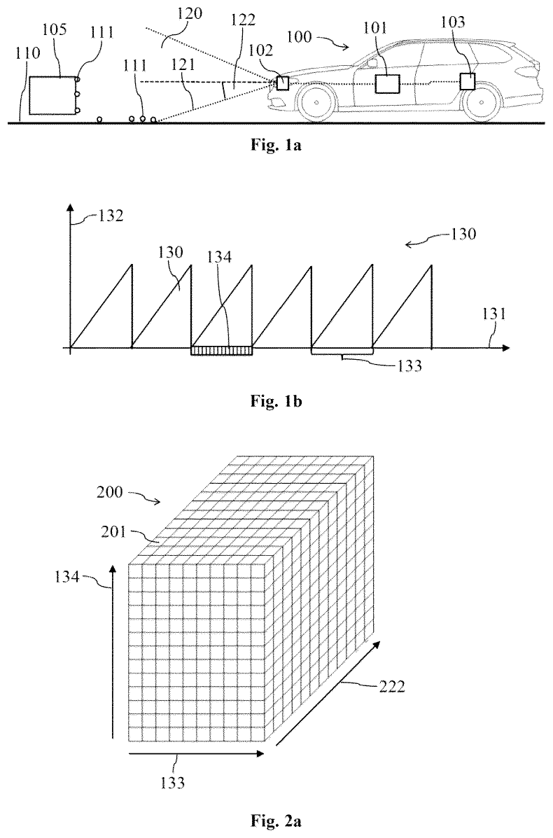

FIG. 1a shows by way of example a reception direction 121 having a specific elevation angle 122. In general, a reception direction 121 can have a specific azimuth and/or elevation angle 122.

The radar sensor 102 can be configured to detect a detection point 111 in a specific detection direction 121 (i.e. for a specific azimuth angle 122 and for a specific elevation angle 122) on the basis of the transmission signal when the transmission signal has been reflected from an object 105 or from the ground 110 on which the vehicle 100 is driving. On the other hand, typically no detection point 111 is detected by the radar sensor 102 when the transmission signal is not reflected. Therefore, a cloud of detection points 111 can be provided by the radar sensor 102 for the detection range 120 of the radar sensor 102, by which one or more objects 105 and possibly the ground 110 in the surroundings of the vehicle 100 are indicated.

A (control) device 101 of the vehicle 100 can be configured to evaluate the sensor data, in particular the cloud of detection points 111, of the radar sensor 102, for example in order to create a surroundings model with respect to the surroundings of the vehicle 100. The device 101 can in particular be configured to provide one or more driving functions on the basis of the sensor data of the radar sensor 102, by which the vehicle 100 is longitudinally and/or laterally guided in an at least semiautomated or completely automated manner. For this purpose, one or more longitudinal and/or lateral guidance actuators 103 (such as a drive motor, a braking device, and/or a steering device) of the vehicle 100 can be actuated.

FIG. 1b shows an exemplary transmission signal 130, which can be emitted by a transmission antenna of the radar sensor 102. The transmission antenna can have a specific emission characteristic here, by which the detection range 120 of the radar sensor 102 is defined and/or established. The transmission signal 130 can have a sequence of frequency ramps 135, wherein the frequency 132 of the transmission signal 130 is initially changed, for example increased (up to a second frequency), continuously or in steps (starting from a first frequency), and at the end of the frequency ramp 135 is abruptly changed back to the first frequency.

The transmission signal 130 can have N frequency ramps 135 along the time 131, for example, N=10 or more, or N=100 or more. A frequency ramp 135 can have a specific ramp duration T here. The individual frequency ramps 135 can be identified via a ramp index n 133, with n=1, . . . , N. A long-term dimension can be defined by the ramp index n 133.

The individual frequency ramps 135 can each be divided into K sampling times, for example, with K=10 or more, or K=100 or more. The individual sampling times are therefore chronologically spaced apart from one another by T/K. The individual sampling times within a frequency ramp 135 can be identified via a sampling index k 134, with k=1, . . . , K. A short-term dimension can be defined by the sampling index k 134.

The radar sensor 102 can furthermore have a set of reception antennas (e.g., 3 or more, or 5 or more, or 10 or more reception antennas), via which reception signals caused by reflections of the transmission signal 130 can be received. The reception antennas can be arranged spatially offset in relation to one another, which enables the direction of incidence of the reception signal on the set of reception antennas to be determined via the time offset of the reception and/or via the phase of a reception signal. The entry direction of the reception signal can be viewed here as the detection direction 121 of the detection point 111 associated with the reception signal.

The radar sensor 102 can possibly have a set of transmission antennas, which are designed to emit transmission signals 130 distinguishable from one another. The transmission antennas can therefore be arranged spatially offset in relation to one another.

Different directions of incidence and therefore different detection directions 121 can be distinguished by the use of multiple reception antennas and/or multiple transmission antennas, which enables detection points 111 to be detected in different detection directions 121, i.e. having different detection angles 122. The radar sensor 102 can be designed to distinguish Q different detection directions 121 or detection angles 122 (for example, Q=10 or more, or Q=100 or more). The Q detection angles 122 can be based on a combination of L transmission antennas and M reception antennas (for example, Q=L×M).

Therefore, Q reception signals for Q different antenna combinations can be detected by the radar sensor 102. The individual reception signals are each based here on a time sequence of frequency ramps 135 (which are also designated as chirps). The individual reception signals can each be sampled at a sampling frequency f (for example, with f=K/T) (possibly following mixing with the original transmission signal 130 in order to generate corresponding intermediate frequency signals for the further signal processing), in order to provide a time sequence of measured values. The time sequence of measured values of a reception signal (or an intermediate frequency signal) can be divided into N groups of K measured values each. Therefore, Q different sequences of measured values can be provided by the radar sensor 102 (for Q different antenna combinations or for Q different detection angles), wherein each sequence of measured values has N chronologically successive groups of K measured values each.

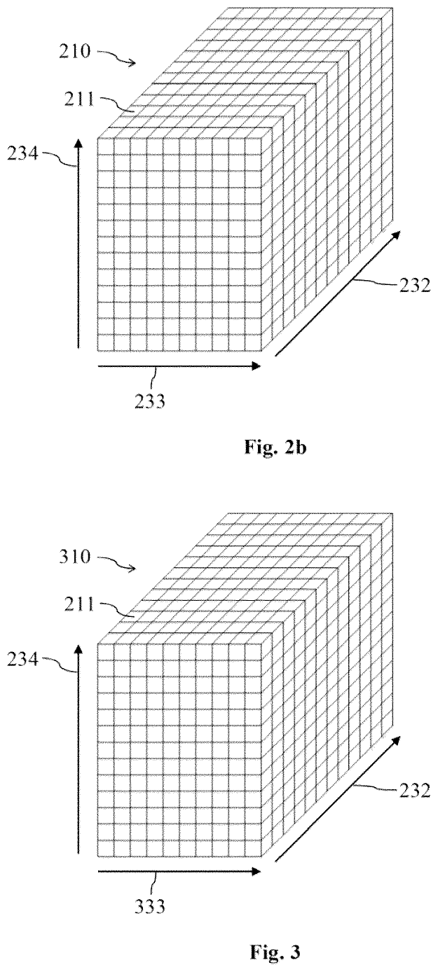

The K×N×Q measured values can be combined (for example, for viewing) in a measured value tensor or radar tensor 200, as shown by way of example in FIG. 2a. The measured value tensor and/or radar tensor 200 can have here
a (long-term) dimension for the ramp index n 133;
a (short-term) dimension for the sampling index k 134; and/or
an (antenna combination) dimension for the combination index q 222 (for the respective antenna combination), with q=1, . . . , Q.

The individual cells 201 of the measured value tensor 200 can each have a measured value x (k, n, q).

It can be shown that the frequency of the intermediate frequency signal (determined by mixing a transmission signal and a reception signal) depends on the radial distance r of the object 105 and on the radial speed v of the object 105 by which the reception signal was generated (by reflection of the transmission signal). Furthermore, it can be shown that the phase of the intermediate frequency signal is proportional to the combination index q 222 (if equidistant (virtual) antennas are used), wherein the proportionality factor depends on the angle of incidence of the reception signal and therefore on the detection angle 122 of the object 105.

To evaluate the measured values x (k, n, q) of the intermediate frequency signals detected by the radar sensor 102, one or more time range-frequency range transforms, in particular fast Fourier transforms (FFT) can be carried out. In particular, in a first step a transform can be carried out along the scanning index or short-term dimension, which enables the radial distance r of a detection point 111 or an object 105 to be determined.

A partially transformed tensor having cells x′ (r, n, q) is provided by the transform along the scanning index or short-term dimension, wherein r corresponds to the radial distance. A relatively high value x′ (r, n, q) indicates that a detection point 111 is located at the time indicated by n, for the antenna combination indicated by q, and at the distance indicated by r. A relatively low value x′ (r, n, q) indicates that no detection point 111 is located at the time indicated by n, in the antenna combination indicated by q, and at the distance indicated by r.

Following the transform along the scanning index or short-term dimension, in a second step a transform can be carried out along the ramp index or long-term dimension. The transform along the ramp index or long-term dimension can be restricted here to a partial sensor (in particular to a matrix) of the partially transformed tensor, for which a relatively high value x′ (r, n, q) exists (for example, a value x′ (r, n, q) which exceeds a specific threshold value).

The speed v, at which the radial distance r of a detection point 111 or an object 105 changes can be determined by this transform along the ramp index or long-term dimension, i.e. the radial speed v of a detection point 111 can be determined.

A partially transformed (partial) tensor having cells x″ (r, v, q) is provided by the additional transform along the ramp index or long-term dimension, wherein v corresponds to the radial speed. A relatively high value x″ (r, v, q) indicates that for the antenna combination indicated by q and at the distance indicated by r, a detection point 111 is located which moves at the radial speed v. A relatively low value x″ (r, v, q) indicates that no detection point 111 is located for the antenna combination indicated by q and at the distance indicated by r.

The detection angle 122 of a detection point 111 and/or object 105 can be identified by a further transform along the combination index dimension. In particular, a transformed tensor 210 (see FIG. 2b) having cells x″′ (r, v, s) 211 can thus be provided, wherein s corresponds to an angle index 232 for identifying the respective detection angle 122. As described above, the phase of the intermediate frequency signals proportional to the combination index q 222 is identified by the individual virtual antennas (i.e. the individual antenna combinations). The proportionality factor, which depends on the detection angle 122, therefore corresponds to a “frequency” with respect to the combination index q 222. This frequency and based thereon the detection angle 122 can be determined on the basis of a frequency band transform along the combination index dimension. A relatively high value x″′ (r, v, s) indicates that for the detection angle 122 indicated by s and at the distance indicated by r, a detection point 111 is located which moves at the radial speed v. A relatively low value x″′ (r, v, s) indicates that no detection point 111 is located at the detection angle 122 indicated by q and at the distance indicated by r.

In FIG. 2b, the distance index r is represented by the reference sign 234, the speed index v by the reference sign 233, and the angle index s by the reference sign 232.

To determine the tangential speed of a detection point 111 or an object 105 corresponding to a detection point 111, the tensor partially transformed by the transform along the scanning index or short-term dimension having cells x′ (r, n, q) can be transformed along the combination dimension to determine a tensor having cells x′*(r, n, s). The transform along the antenna combination dimension can be restricted here to a partial tensor (in particular to a matrix) of the partially transformed tensor, for which a relatively high value x′ (r, n, q) exists (for example, a value x′ (r, n, q) which exceeds a specific threshold value).

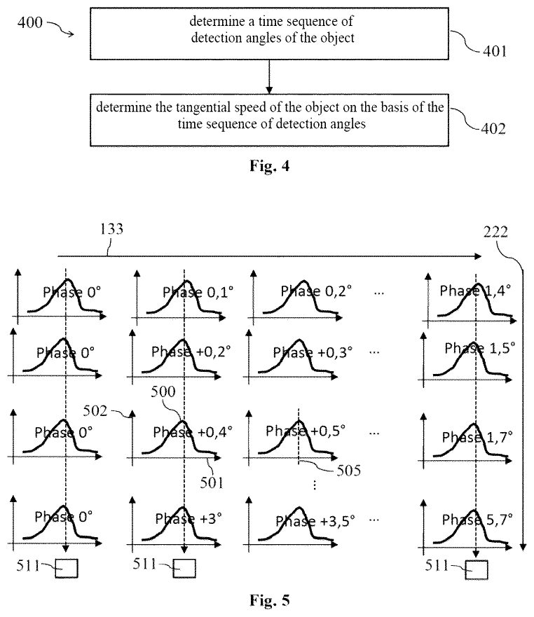

The frequency band transform along the combination dimension is illustrated by way of example in FIG. 5. In particular, N x Q shows frequency spectra 500 of the intermediate frequency signals, wherein in FIG. 5 the long-term dimension having the ramp index 133 extends in the horizontal direction and wherein the combination dimension having the combination index 222 extends in the vertical direction. The individual frequency spectra 500 have been determined by the frequency band transform along the scanning and/or short-term dimension for a specific ramp index 133 and for a specific combination index 222 in each case. A frequency spectrum 500 indicates the amplitude or the signal energy 502 as a function of a frequency 501 here, wherein the different frequencies 501 each correspond to different radial distances r. The frequencies 501 can therefore correspond to the distance index 234 of the partially transformed tensor x′ (r, n, q). The frequency 505, which corresponds to the amplitude and/or energy maximum 505 of a frequency spectrum 500, indicates the radial distance r of an object 105 or a detection point 111.

FIG. 5 shows exemplary frequency spectra 500 for an object 105, which has a fixed radial distance r and moves at a specific tangential speed. The tangential movement of the object 105 has the result that the detection angle 122 of the object 105 changes along the ramp index or long-term dimension. As described above, the phase of the intermediate frequency signal is proportional to the combination index 222, wherein the proportionality factor depends on the detection angle 122.

Exemplary values of the phases of the individual intermediate frequency signals are indicated in FIG. 5. The intermediate frequency signals in the left column (for the ramp index n=1) for all combination indexes q=1, . . . , Q have a phase having the value 0° here, from which it can be concluded that the detection angle 122 of the object 105 is 0°. Due to the tangential movement of the object 105, the detection angle 122 of the object 105 changes with increasing ramp index, which has the result that the intermediate frequency signals in the columns n>1 each have a phase having a value>0°. The values of the phases of the intermediate frequency signals within a column (i.e. for a specific ramp index n) increase here with increasing combination index q. The increase of the phase values within a column is dependent here on the angle of incidence 122 of the object 105 at the time corresponding to the specific ramp index n.

By way of a frequency band transform along the combination dimension, a frequency 511 can be determined for each ramp index n, which indicates the angle of incidence 122 of the object 105 at the time corresponding to the respective ramp index n. The frequency 511 is typically proportional to the sine or the cosine of the angle of incidence 122.

A time sequence of frequencies 511 and, based thereon, a time sequence of angles of incidence 122 can therefore be determined (for the corresponding sequence of ramp indexes n=1, . . . , N). Based on the time sequence of angles of incidence 122, a value of the tangential speed of the object 105 can be determined (for example by linear regression and/or by a frequency band transform).

The tensor partially transformed by the transform along the scanning index or short-term dimension, having cells x′ (r, n, q), can therefore be transformed (for example, for part of the tensor) along the combination dimension to determine a (partial) tensor having cells x′*(r, n, s). A relatively high value x′*(r, n, s) indicates that a detection point 111 is located at the time indicated by n, for the detection angle 122 indicated by s, and at the distance indicated by r. A relatively low value x′*(r, n, s) indicates that no detection point 111 is located at the time indicated by n, for the detection angle 122 indicated by s, and at the distance indicated by r.

This tensor can be transformed (for example, partially) along the ramp index or long-term dimension in order to provide the completely transformed tensor 310 having cells x′**(r, w, s) 311 (see FIG. 3), wherein w indicates the tangential speed of a detection point 111. In particular, w indicates the speed at which the detection angle 122 of a detection point 111 changes. This (angular) speed gives information about the speed of the detection point 111 in the tangential direction (with respect to the detection direction 121 of the detection point 111).

In FIG. 3, the distance index r is represented by the reference sign 234, the speed index w (for the tangential speed) by the reference sign 333, and the angle index s by the reference sign 232.

As described above, up to four dimensions can be determined directly by measurement by a radar sensor 102, in particular the radial distance, the azimuth angle, the elevation angle, and/or the radial speed. These dimensions can be transformed as needed into a Cartesian coordinate system. An object 105 to be measured, which moves tangentially to the vehicle 100 and therefore to the radar sensor 102 (such as a preceding vehicle which moves laterally due to a lane change) can usually first be recognized with respect to its lateral movement via a chronological observation (i.e. via tracking) of the object 105, and not by a direct measurement. The determination of the tangential speed of an object 105 is thus delayed in time and averaged, which can result in disadvantages in the surroundings detection and as a result in an impairment of a functional embodiment of a driving function. For example, the speed of a driving maneuver of the vehicle 100 can thus be limited. Furthermore, the accuracy of the determination of the tangential speed of the object 105 can be limited, which can result in a restriction of a driving maneuver of the vehicle 100.

As described in this document, a direct determination of the tangential speed can be effectuated by means of an analysis of the angle spectra per frequency ramp (i.e. chirp) over the time sequence of frequency ramps. This can take place analogously to the Doppler determination in a fast chirp FMCW (frequency modulated continuous wave) radar sensor, in which the intermediate frequency phase from chirp to chirp corresponds to the Doppler frequency.

In an angle formation method, for example for determining the azimuth angle, a power spectrum can be generated by means of digital beamforming, which has its peak at the most probable angle 122 of a detection point 111. This typically takes place after the calculation of a two-dimensional FFT of all FMCW chirps, to determine the distance and the Doppler speed of the one or more objects 105.

As described in this document, the (phase) differences of the beamforming power spectrum can already be observed on the basis of the individual chirps overall (virtual) antennas 222. The time offset of the chirps results in a change of the phase relationships of the antennas 222 in relation to one another over the time 131. A tangentially moving object 105 thus generates a (spatially) shifted spectrum over the time 131 in each case. The observed period of time is typically sufficiently small here that a reflection point travel is improbable, since the geometrical situation only changes slightly. A chronological change of the beamforming spectrum can therefore be assigned to precisely one object 105.

The chronological tracking of the change of the beamforming power spectrum can be effectuated depending on the embodiment via a comparison (for example via tracking) or, in the case of relatively smaller differences, via a frequency transform (such as an FFT).

An FFT implementation is described in conjunction with FIG. 3. After the first FFT (to determine the radial distance), an FFT is also made over the (virtual) antenna channels q on the basis of the individual chirps or frequency ramps in order to form an angle spectrum. The change of the angle spectrum can be determined along the chirps (i.e. along the ramp index n) by means of a further FFT. The result represents a tangential speed for each range/angle peak by use of an FFT. In particular, a frequency results which corresponds to the tangential speed of a detection point 111 previously identified in the range or distance spectrum.

The above-mentioned signal processing steps can possibly be carried out in parallel or in series in order to determine the radial speed and the tangential speed (Doppler FFT along the chirps, angle FFT along the antenna channels on the basis of all chirps).

Multiple (laterally distributed) radar sensors 102 can possibly be used, which are operated coherently or non-coherently. The tangential speed of an object 105 can thus be determined with increased accuracy.

FIG. 4 shows a flow chart of a (possibly computer-implemented) method 400 for determining speed information with respect to the tangential speed of an object 105 in the surroundings of a radar sensor 102. The tangential speed of an object 105 can in this case be the speed of the movement of the object 105 tangentially to a detection direction 121 of the radar sensor 102.

The radar sensor 102 is designed to emit a transmission signal 130, and to receive a corresponding plurality of reception signals at a plurality of reception antennas, each of which is dependent on the transmission signal 130 (for example, due to a reflection at the object 105). The transmission signal 130 has a frequency ramp 135 in each of N chronologically successive time intervals. The frequency ramp 135 can have a frequency here which changes within the respective time interval (for example, so that a transmission signal 130 results which has a sawtooth-shaped frequency modulation).

The method 400 comprises determining 401, on the basis of the plurality of reception signals and on the basis of the transmission signal 130 (for example, by mixing the plurality of reception signals with the transmission signal 130), for each of the N time intervals, angle information 511 with respect to the detection angle 122 for the object 105 (in the respective time interval). The angle information 511 can correspond, for example, to a frequency by which the detection angle 122 is indicated. For example, the frequency determined (on the basis of a frequency band transform, such as a Fourier transform) can be proportional to the cosine or the sine of the detection angle 122.

The method 400 furthermore comprises determining 402 the speed information with respect to the tangential speed of the object 105 on the basis of the chronological sequence of angle information 511 with respect to the detection angle 122. In particular the gradient of the change of the angle information 511, in particular of the detection angle 122, can be determined here to determine the tangential speed of the object 105. The angular speed at which the detection angle 122 changes with the time (i.e. along the N time intervals) can be determined, for example. The tangential speed of the object 105 can be determined in an efficient and precise manner based on the angular speed (in consideration of the radial distance of the object 105).

The present invention is not restricted to the exemplary embodiments shown. In particular, it is to be noted that the description and the figures are only to illustrate the principle of the proposed methods, devices, and systems by way of example.

1-12. (canceled)

13. A device for determining speed information with respect to a tangential speed of an object in a surroundings of a radar sensor;
wherein the radar sensor is configured to:
emit a transmission signal; and
receive a corresponding plurality of reception signals at a plurality of reception antennas, each of which is dependent on the transmission signal;
wherein the transmission signal has a frequency ramp in each of N chronologically successive time intervals;
wherein the device is configured to:
determine angle information with respect to a detection angle for the object for each of the N time intervals on the basis of the plurality of reception signals and on the basis of the transmission signa; and
determine the speed information with respect to the tangential speed of the object on the basis of the time sequence of angle information with respect to the detection angle.

14. The device according to claim 13, wherein the device is configured to:
determine the speed information with respect to the tangential speed of the object on the basis of a change of the angle information along the N time intervals.

15. The device according to claim 14, wherein the change in angle information comprises a change of the detection angle along the N time intervals.

16. The device according to claim 14, wherein the device is configured to:
determine a gradient, with which the angle information changes along the N time intervals; and
determine the speed information with respect to the tangential speed of the object on the basis of the gradient.

17. The device according to claim 14, wherein the device is configured to:
determine Q intermediate frequency signals on the basis of the plurality of reception signals and on the basis of the transmission signal by mixing one reception signal in each case with the transmission signal, with Q>1; and
determine the time sequence of angle information with respect to the detection angle on the basis of the Q intermediate frequency signals.

18. The device according to claim 17, wherein the device is configured, for a specific time interval of the N time intervals, to:
determine a value of a phase of the respective intermediate frequency signal in the specific time interval for each of the Q intermediate frequency signals; and
determine the angle information with respect to the detection angle for the object in the specific time interval on the basis of the Q values of the phase of the Q intermediate frequency signals in the specific time interval.

19. The device according to claim 18, wherein the device is configured to:
determine a frequency spectrum on the basis of a frequency band transform of the sequence of Q values of the phase of the Q intermediate frequency signals in the specific time interval; and
determine the angle information with respect to the detection angle for the object in the specific time interval on the basis of the determined frequency spectrum.

20. The device according to claim 13, wherein:
the device is configured to determine a radar tensor having a plurality of cells on the basis of the plurality of reception signals and on the basis of the transmission signal;
the radar tensor has a long-term dimension;
the radar tensor comprises a partial tensor having cells along the long-term dimension for each of the N time intervals;
the partial tensor has a short-term dimension;
the partial tensor comprises a cell along the short-term dimension for each of K sampling times of a frequency ramp;
the partial tensor has a combination dimension;
the partial tensor comprises a cell along the combination dimension for each of Q different combinations of a reception signal with the transmission signal; and
the device is configured, for each of the N partial tensors for the corresponding N time intervals:
to carry out a frequency band transform in each case along the short-term dimension to determine distance information with respect to a radial distance of the object; and
for cells which correspond to the determined radial distance of the object, to carry out a frequency band transform along the combination dimension, in order to determine the angle information with respect to the detection angle for the object for the respective time interval.

21. The device according to claim 20, wherein the device is configured to:
for cells which correspond to the determined radial distance of the object, carry out a frequency band transform along the long-term dimension without a frequency band transform previously having taken place along the combination dimension; and
determine speed information with respect to a radial speed of the object based on the frequency band transform along the long-term dimension.

22. The device according to claim 20, wherein the device is configured to:
determine a corresponding plurality of intermediate frequency signals on the basis of the plurality of reception signals and on the basis of the transmission signal, by using a mixer; and
determine measured values for the plurality of cells of the radar tensor on the basis of the plurality of intermediate frequency signals, by sampling the plurality of intermediate frequency signals.

23. The device according to claim 13, wherein the tangential speed of the object is a speed of a movement of the object tangentially to a detection direction of the radar sensor.

24. The device according to claim 13, wherein the device is configured to:
determine L corresponding time sequences of angle information with respect to the detection angle of the object on the basis of L radar sensors arranged adjacent to one another, with L>1; and
determine the speed information with respect to the tangential speed of the object on the basis of the L time sequences of angle information with respect to the detection angle of the object.

25. A method for determining speed information with respect to a tangential speed of an object in a surroundings of a radar sensor, wherein the radar sensor is designed to emit a transmission signal, and to receive a corresponding plurality of reception signals at a plurality of reception antennas, which are each dependent on the transmission signa, and wherein the transmission signal has a frequency ramp in each of N chronologically successive time intervals, the method comprising:
determining, on the basis of the plurality of reception signals and on the basis of the transmission signal, angle information with respect to a detection angle for the object for each of the N time intervals; and
determining the speed information with respect to the tangential speed of the object on the basis of the time sequence of angle information with respect to the detection angle.
